(19) United States
(12) Patent Application Publication
(10) Pub. No.: US 2016/0277465 A1
(43) Pub. Date: Sep. 22, 2016

(54) METHOD AND SYSTEM FOR CLIENT-SERVER REAL-TIME INTERACTION BASED ON STREAMING MEDIA

(71) Applicant: TENCENT TECHNOLOGY (SHENZHEN) COMPANY LIMITED, Shenzhen (CN)

(72) Inventors: Jie Hou, Shenzhen (CN); Dadong Xie, Shenzhen (CN); Hailong Liu, Shenzhen (CN); Bo Chen, Shenzhen (CN)

(21) Appl. No.: 15/165,478

(22) Filed: May 26, 2016

Related U.S. Application Data
(63) Continuation of application No. PCT/CN2015/071766, filed on Jan. 28, 2015.

(30) Foreign Application Priority Data
Jun. 13, 2014 (CN) 201410265727.2

(51) Int. Cl. H04L 29/06; H04N 21/2387; G06F 17/30; H04N 21/8547

(52) U.S. Cl. CPC H04L 65/4084; H04L 65/602; H04N 21/8547; H04N 21/2387; G06F 17/30044; G06F 17/30867; H04L 67/42

(57) ABSTRACT

A method of processing real-time streaming media is performed at a computer system having one or more processors and a memory. The computer system obtains a streaming media based search request from a terminal, the search request including information from a streaming media data packet captured by the terminal. After extracting a set of streaming media features from the streaming media data packet, the computer system searches a plurality of streaming media feature sequences, each sequence corresponding to a respective streaming media source end, for a feature segment that matches the extracted set of streaming media features. After acquiring a playback timestamp of the matching feature segment and a corresponding source end identifier, the computer system searches for preconfigured interaction response information that corresponds to the acquired source end identifier and the playback timestamp and returns the corresponding interaction response information to the terminal.

### CROSS REFERENCE TO RELATED APPLICATION

This is a continuation application of International Patent Application No. PCT/CN2015/071766, filed on Jan. 28, 2015, which claims priority to Chinese Patent Application No. 201410265727.2, entitled “METHOD AND SYSTEM FOR CLIENT-SERVER REAL-TIME INTERACTION BASED ON STREAMING MEDIA” filed on Jun. 13, 2014, which are incorporated herein by reference in their entirety.

### TECHNICAL FIELD

The present application relates to the field of streaming media identification technologies and network technologies, and in particular, to method and system for client-server real-time interaction based on streaming media.

### BACKGROUND

Streaming media is also referred to as streaming media. The streaming media refers to a form of transmitting multimedia files, such as audios and videos, on a network in a streaming manner. A streaming media file format is a media format that supports and uses streaming transmission and playback. A streaming transmission mode is to divide a multimedia file, such as a video or an audio, into compressed packages in a special compression manner, and transmit the compressed packages from one end to another end continuously and in real time. In a system that uses the streaming transmission mode, a receiving party does not need to wait, as the receiving party does in a non-streaming playback mode, until the whole file is downloaded to see content of a file, but can play a streaming media file, such as a compressed video or audio, by using a corresponding player only after a startup delay of several seconds or tens of seconds; and the remaining part continues to be downloaded until playback is finished. In this process, a series of related packages are referred to as “stream”. Streaming media, in fact, refers to a new media transmission mode, but not a new type of media.

As mobile communications technologies and network technologies develop day by day, communications technologies, such as telephone communications, SMS message communications, and network instant messaging, are used widely in all aspects of the daily life of people. In order to meet ever-growing requirements of people for spiritual life, news and variety shows, such as various television programs and radio programs, become highly enriched. These news and variety shows often perform, in combination with the communications technologies, some interactive activities with spectators or listeners. In an interactive activity, a news and variety show announces its interactive communication number; when participating in program interaction, a spectator or listener needs to input the communication number of the news and variety show into a communications terminal, then enter text or image interactive information and record and input voice interactive information, and send the interactive information to a program platform corresponding to the communication number of the news and variety show; and afterwards, the program platform returns corresponding interaction response information to the communications terminal of the spectator or listener, thereby implementing the interactive activity of the spectator or listener for the news and variety show.

However, in the interactive activity, the communications terminal needs to acquire a target communication number and interactive information content from the input of a user. Usually, it needs to take a long time for the user to input the target communication number and the interactive information content, while a news and variety show is played forward unceasingly; therefore, when the communications terminal receives the corresponding interaction response information after sending the interactive information content, the news and variety show may have been played forward for a long time. As a result, it is difficult to ensure that the interactive activity and playback of the program are performed simultaneously and in real time.

### SUMMARY

The above deficiencies and other problems associated with the conventional approach of processing real-time streaming media are reduced or eliminated by the present application disclosed below. In some embodiments, the present application is implemented in a computer system that has one or more processors, memory and one or more modules, programs or sets of instructions stored in the memory for performing multiple functions. Instructions for performing these functions may be included in a computer program product configured for execution by the computer system.

In accordance with some embodiments of the present application, a computer-implemented method for processing real-time streaming media is performed at a computer system having one or more processors and memory for storing computer-executable instructions to be executed by the processors. The method includes: obtaining a streaming media based search request from a terminal, the streaming media based search request including information from a streaming media data packet captured by the terminal; extracting a set of streaming media features from the streaming media data packet; searching a plurality of streaming media feature sequences, each streaming media feature sequence corresponding to a respective streaming media source end, for a feature segment that matches the extracted set of streaming media features; acquiring a playback timestamp of the matching feature segment and a source end identifier of the corresponding streaming media source end; searching for preconfigured interaction response information that corresponds to the acquired source end identifier and the playback timestamp; and returning the corresponding interaction response information to the terminal. In accordance with some embodiments of the present application, a computer system includes one or more processors; and memory with computer-executable instructions stored thereon that, when executed by the one or more computer processors, cause the one or more computer processors to perform the method mentioned above. In accordance with some embodiments of the present application, a non-transitory computer readable storage medium stores computer-executable instructions to be executed by a computer system that includes one or more processors and memory for performing the method mentioned above.

### BRIEF DESCRIPTION OF THE DRAWINGS

The aforementioned features and advantages of the present application as well as additional features and advantages thereof will be more clearly understood hereinafter as a result of a detailed description of preferred embodiments when taken in conjunction with the drawings.

FIG. 1 is a schematic flowchart of a client-server real-time interaction method based on streaming media in some embodiments;

FIG. 2A is a schematic flowchart of a method of a server updating a corresponding streaming media feature sequence in real time according to a plurality of streaming media data packets sent in real time by each streaming media source end in some embodiments;

FIG. 2B is a schematic block diagram of a data structure for storing a streaming media feature sequence in some embodiments;

FIG. 2C is a schematic block diagram of a data structure for storing interaction response information associated with a streaming media segment in some embodiments;

FIG. 3 is a schematic architectural diagram of a simulation application scenario of a client-server real-time interaction method based on streaming media in some embodiments;

FIG. 4 is a schematic structural diagram of a real-time interaction system based on streaming media in some embodiments;

FIG. 5 is a schematic structural diagram of a real-time interaction system based on streaming media in some other embodiments;

FIG. 6 is a schematic structural diagram of a real-time interaction system based on streaming media in yet some other embodiments; and

FIG. 7 is a schematic flowchart of a client-server real-time interaction method based on streaming media in some embodiments.

Like reference numerals refer to corresponding parts throughout the several views of the drawings.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

To make the objective, technical solutions, and advantages of the present application clearer, the following further describes the present application in detail with reference to accompanying drawings and embodiments. It should be understood that specific embodiments described herein are merely used to describe the present application, and are not intended to limit the present application.

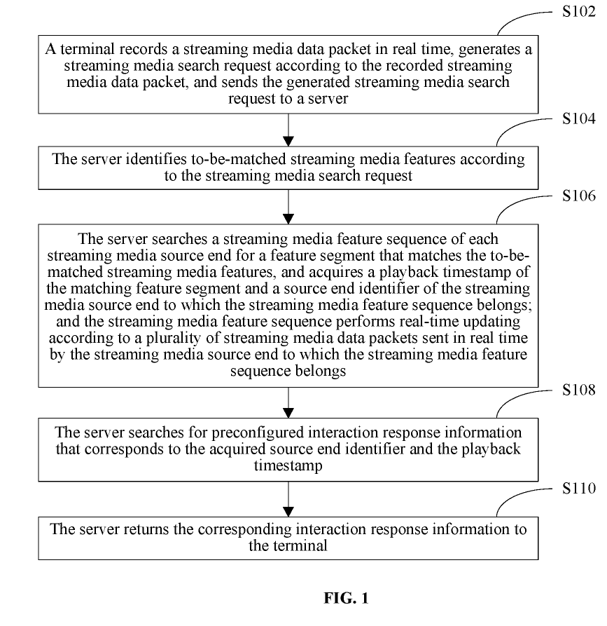

As shown in FIG. 1, in some embodiments, a client-server real-time interaction method based on streaming media includes the following steps:

Step S102. A terminal records a streaming media data packet in real time, generates a streaming media search request according to the recorded streaming media data packet, and sends the generated streaming media search request to a server.

The recording of a streaming media data packet in real time may include recording sounds, images, and/or videos in real time from a surrounding environment, to obtain a streaming media data packet. When a multimedia playback device in an environment in which the terminal is located plays multimedia content, sounds, images, and/or videos must occur in the environment in which the terminal is located. In some embodiments, when the terminal receives a recording command triggered by a user, the terminal may start real-time recording of a streaming media data packet of the multimedia content. After recording for a preset duration, the terminal ends the real-time recording of the streaming media data packet. The terminal may turn on an audio and video recorder (or a multimedia recorder), such as a microphone or a camera, record, by using the audio and video recorder which is turned on, sounds, images, and/or videos currently occurring in an environment in which the terminal is located, to obtain multimedia data, and generate a streaming media data packet according to recorded multimedia data.

Further, in some embodiments, the terminal may encapsulate the streaming media data packet in the streaming media search request. In another embodiment, the terminal may extract streaming media features of the streaming media data packet, and encapsulate the extracted streaming media features in the streaming media search request. The encapsulating the streaming media features of the streaming media data packet in the streaming media search request may reduce the amount of data included in the streaming media search request, and save a network bandwidth that is occupied during transmission of the streaming media search request.

Step S104. The server identifies to-be-matched streaming media features according to the streaming media search request.

In some embodiments, the streaming media search request includes the streaming media data packet, and the server may extract the streaming media data packet included in the streaming media search request, and further extract the streaming media features of the streaming media data packet. In another embodiment, the streaming media search request includes the streaming media features, and the server may directly extract the streaming media features from the streaming media search request.

Multimedia content indicated by the streaming media data packet may include audios, images, videos, or the like, and the streaming media features acquired by the server vary as multimedia content indicated by the streaming media data packet varies. Correspondingly, the acquired streaming media features may include audio features, image features, video features (audio features and image features), or the like.

In some embodiments, the audio features may be an audio fingerprint. An audio fingerprint of an audio data packet may uniquely identify melody features of an audio indicated by the audio data packet. A method for extracting the audio fingerprint includes but is not limited to an MFCC algorithm, where MFCC is an abbreviation of Mel Frequency Cepstrum Coefficient. In some embodiments, an image feature extraction method includes but is not limited to: a Fourier transform method, a windowed Fourier transform method, a wavelet transform method, a least square method, an edge direction histogram method, and texture feature extraction based on Tamura texture features.

Step S106. The server searches a streaming media feature sequence of each streaming media source end for a feature segment that matches the to-be-matched streaming media features, and acquires a playback timestamp of the matching feature segment and a source end identifier of the streaming media source end to which the streaming media feature sequence belongs; and the streaming media feature sequence performs real-time updating according to a plurality of streaming media data packets sent in real time by the streaming media source end to which the streaming media feature sequence belongs.

The streaming media feature sequence of the streaming media source end is a streaming media feature sequence that is extracted according to a streaming media data packet sequence of the streaming media source end, one or more streaming media data packets correspond to one streaming media feature, multiple streaming media features combine to form a streaming media feature sequence, a feature segment is a segment of streaming media features, and the feature segment includes one or more streaming media features. Therefore, the matching feature segment corresponds to a column of streaming media data packets, and the playback timestamp of the matching feature segment corresponds to a playback timestamp of multimedia content corresponding to the column of streaming media data packets. Each playback timestamp corresponds to specific multimedia playback content, and therefore, each playback timestamp of each streaming media source end may represent specific interactive information content, so that specific interaction response information can be preset for each playback timestamp of each streaming media source end.

Step S108. The server searches for the preconfigured interaction response information that corresponds to the acquired source end identifier and the playback timestamp.

In some embodiments, the foregoing client-server real-time interaction method based on streaming media further includes the following step: setting, by the server, the source end identifier and the interaction response information that corresponds to the playback timestamp, where the interaction response information may be set according to the source end identifier and specific multimedia playback content that corresponds to the playback timestamp.

For example, if multimedia playback content corresponding to a playback timestamp of a streaming media source end is to vote for a contestant xx, the terminal records multimedia playback content in an environment in which the terminal is located to obtain a streaming media data packet, further generates a streaming media search request, and sends the streaming media search request to the server, which may be equivalent to that the terminal sends, to the server, interactive information content that indicates “vote for the contestant”; in this way, a source end identifier of the streaming media source end may be preset and interaction response information that corresponds to the playback timestamp may be preset as “succeed in voting for the contestant xx”.

For another example, if multimedia playback content corresponding to a playback timestamp of a streaming media source end is a link, in an award-winning question and answer activity, of acquiring question content, the terminal records the multimedia playback content in an environment in which the terminal is located to obtain a streaming media data packet, further generates a streaming media search request, and sends the streaming media search request to the server, which may be equivalent to that the terminal sends, to the server, interactive information content that indicates “request acquiring the question content”; in this way, a source end identifier of the streaming media source end may be preset and interaction response information that corresponds to the playback timestamp may be preset to include the question content.

For another example, if multimedia playback content corresponding to a playback timestamp of a streaming media source end is a link of announcing a communication account, the terminal records the multimedia playback content in an environment in which the terminal is located to obtain a streaming media data packet, further generates a streaming media search request, and sends the streaming media search request to the server, which may be equivalent to that the terminal sends, to the server, interactive information content that indicates “request following the communication account” or “request adding the communication account to a friend list”; in this way, a source end identifier of the streaming media source end may be preset and interaction response information that corresponds to the playback timestamp may be preset to include an interactive interface, where the interactive interface is used to determine whether a user confirms to “follow the communication account” or “add the communication account to a friend list”. The terminal may further receive a user command through the interactive interface, and follow the communication account or add the communication account to a friend list according to the user command.

For another example, if multimedia playback content corresponding to a playback timestamp of a streaming media source end is a news and variety show, such as a teleplay, the terminal records the multimedia playback content in an environment in which the terminal is located to obtain a streaming media data packet, further generates a streaming media search request, and sends the streaming media search request to the server, which may be equivalent to that the terminal sends, to the server, interactive information content that indicates “comment on current program content”; in this way, a source end identifier of the streaming media source end may be preset and interaction response information that corresponds to the playback timestamp may be preset to include an interactive interface, where the interactive interface is used to receive and submit a comment of a user on the current program content.

For another example, if multimedia playback content corresponding to a playback timestamp of a streaming media source end is a link of collecting feelings about watching/listening to a news and variety show, such as a teleplay, the terminal records the multimedia playback content in an environment in which the terminal is located to obtain a streaming media data packet, further generates a streaming media search request, and sends the streaming media search request to the server, which may be equivalent to that the terminal sends, to the server, interactive information content that indicates “request expressing feelings about watching/listening to a program”; in this way, a source end identifier of the streaming media source end may be preset and interaction response information that corresponds to the playback timestamp may be preset to include an interactive interface, where the interactive interface is used to receive and submit feelings of a user on a teleplay.

For another example, if multimedia playback content corresponding to a playback timestamp of a streaming media source end is a link of introducing product information related to a product, the terminal records the multimedia playback content in an environment in which the terminal is located to obtain a streaming media data packet, further generates a streaming media search request, and sends the streaming media search request to the server, which may be equivalent to that the terminal sends, to the server, interactive information content that indicates “require buying the product” or “hope to know more details about the product”; in this way, a source end identifier of the streaming media source end may be preset and interaction response information that corresponds to the playback timestamp may be preset to include an interactive interface, where the interactive interface is used to display the details about the product or/and receive and submit a product buying command of a user.

The server may divide the playback timestamp into time segments as required, for example, the length of each time segment is 5 minutes. The server may set that playback timestamps, which belong to a same time segment, of a certain streaming media source end correspond to same interaction response information, and the length of the time segment determines time granularity of the interaction response information.

Step S110. The server returns the corresponding interaction response information to the terminal.

In some embodiments, the foregoing client-server real-time interaction method based on streaming media further includes the following step: playing, by the terminal, the interaction response information. The terminal may parse the interaction response information, and play the interaction response information by selecting corresponding software according to audios, images and/or videos included in the interaction response information.

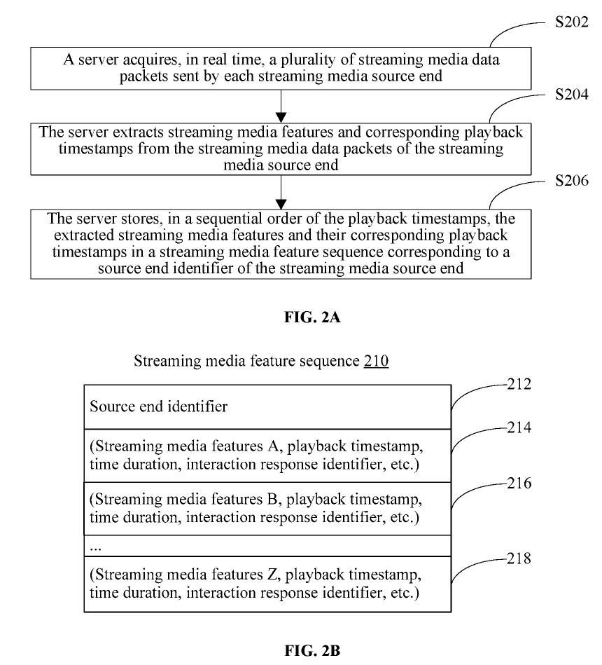

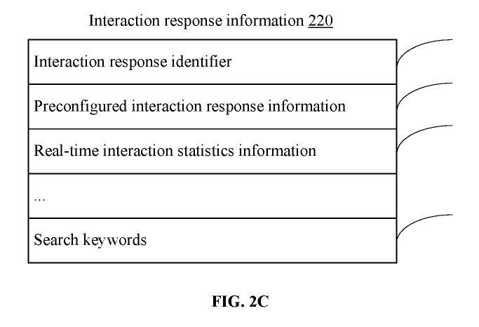

In some embodiments, the foregoing client-server real-time interaction method based on streaming media further includes a method of the server updating a corresponding streaming media feature sequence in real time according to a plurality of streaming media data packets sent in real time by each streaming media source end. As shown in FIG. 2A, in some embodiments, the method includes the following steps:

Step S202. The server acquires, in real time, a streaming media data packet sent by each streaming media source end.

The server and the streaming media source end may agree on a network transmission protocol in any form, such as a TCP protocol or a UDP protocol. In some embodiments, the server may receive, in push mode, the streaming media data packet sent by each streaming media source end. In push mode, the server may listen on a locally preset port, and wait for the streaming media source end to send the streaming media data packet to the port. In another embodiment, the server may receive, in pull mode, the streaming media data packet sent by each streaming media source end. In pull mode, the streaming media source end provides a streaming media data packet on a preset port of the server in a network environment in which the streaming media source end is located, and the server proactively pulls the streaming media data packet from the preset port.

Step S204. The server extracts streaming media features and corresponding playback timestamps from the streaming media data packets of each streaming media source end.

In some embodiments, the server may parse a streaming media data packet, to obtain a multimedia type (such as audio, image, or video) encapsulated in the streaming media data packet and a multimedia encapsulation format (for example, a TS format is used for encapsulation, and a MP3 format with a sampling rate of 48 k is used for coding), further decode multimedia data in the streaming media data packet according to the encapsulated multimedia type and the multimedia encapsulation format, and further extract streaming media features and a playback timestamp of the multimedia data.

In some embodiments, the server may extract a streaming media feature and a playback timestamp from one streaming media data packet, or may extract a streaming media feature and a playback timestamp from multiple streaming media data packets. A playback timestamp of one streaming media data packet may be a playback start time point of multimedia playback content corresponding to the streaming media data packet, and playback timestamps of multiple streaming media data packets may be earliest playback start time points of multiple corresponding pieces of multimedia playback content.

Step S206. The server stores, in a sequential order of the playback timestamps, the extracted streaming media features and their corresponding playback timestamps in a streaming media feature sequence corresponding to a source end identifier of the streaming media source end to which the streaming media features belong.

The streaming media source end to which the streaming media features belong is a streaming media source end to which the streaming media data packet corresponding to the streaming media features belongs. The server may form the streaming media features and the playback timestamp of each streaming media data packet into a media feature data tuple, form multiple media feature data tuples of a same streaming media source end into a streaming media feature sequence of the streaming media source end, further sort the multiple media feature data tuples within the sequence according to the corresponding playback timestamps, and correspondingly store the sorted media feature data tuples and corresponding source end identifiers in a data structure. FIG. 2B is a schematic block diagram of a data structure for storing a streaming media feature sequence 210 in some embodiments. In this example, the streaming media feature sequence 210 is associated with a source end identifier 212, which identifies a streaming media source end from which the streaming media feature sequence 210 is generated. The streaming media feature sequence 210 includes multiple media feature data tuples (214, 216, 218). Each media feature data tuple includes a set of streaming media features extracted from corresponding streaming media content and a playback timestamp indicating the location of the corresponding streaming media content. In some embodiments, each media feature data tuple further includes a time duration indicating the length of the corresponding streaming media content and an interaction response identifier identifying interaction response information to be returned to the requesting terminal in connection with a streaming media search request.

FIG. 2C is a schematic block diagram of a data structure for storing interaction response information 220 associated with a streaming media segment in some embodiments. In this example, the interaction response information 220 includes a corresponding interaction response identifier 222 that uniquely identifies the interaction response information 220 and is used by the streaming media feature sequence 210. In addition, the interaction response information 220 includes preconfigured interaction response information 224. As described above in connection with FIG. 1, the preconfigured interaction response information 224 may be a survey or question uniquely associated with the particular streaming media segment. In some embodiments, the interaction response information 220 further includes real-time interaction statistics information 226, which may be derived from other viewers' interactions with the server. In some embodiments, the interaction response information 220 further includes one or more search keywords 228, which may be uniquely associated with the content of the streaming media segment and can be used to retrieve other relevant information from a search engine.

In some embodiments, a time interval between the earliest playback timestamp and the latest playback timestamp that correspond to the streaming media features in the streaming media feature sequence is maintained within a threshold.

In some embodiments, step S206 includes the following steps: periodically checking whether a time interval between the earliest playback timestamp and the latest playback timestamp that correspond to the streaming media feature sequence reaches the threshold; if not, appending the extracted streaming media features and the corresponding playback timestamps to the end of the streaming media feature sequence; and if yes, determining a number of the extracted streaming media features to be added to the streaming media feature sequence, removing the same number of streaming media features that have the earliest playback timestamps from the streaming media feature sequence, and appending the extracted streaming media features and the corresponding playback timestamps to the end of the streaming media feature sequence.

In some embodiments, the server may preset a threshold for a time interval between the earliest playback timestamp and the latest playback timestamp that correspond to already stored streaming media features, such as 1 hour, 30 minutes, or 5 minutes. In some embodiments, the server may acquire a data amount of the streaming media feature sequence at a time when a time interval between the earliest playback timestamp and the latest playback timestamp that correspond to the streaming media feature sequence reaches the threshold, where the streaming media features in the streaming media feature sequence are sorted according to playback timestamps. Further, a capacity of a circular buffer may be set as the data amount of the streaming media feature sequence at a time when the time interval between the earliest playback timestamp and the latest playback timestamp reaches the threshold. Further, the extracted streaming media features are stored, in a manner of the circular buffer and in the sequential order of the corresponding playback timestamps, in the streaming media feature sequence corresponding to the source end identifier of the streaming media source end to which the streaming media features belong, and the time interval between the earliest playback timestamp and the latest playback timestamp that correspond to the streaming media features in the streaming media feature sequence are made to maintain within the threshold.

In some embodiments, the foregoing client-server real-time interaction method based on streaming media further includes the following step: generating, by the server, an index for a stored streaming media feature sequence of each streaming media source end. In this embodiment, in Step S106, the index of the streaming media feature sequence of each streaming media source end may be searched for an index segment that matches to-be-matched streaming media features, and a feature segment that matches the to-be-matched streaming media features is obtained according to the matching index segment.

In some embodiments, the foregoing client-server real-time interaction method based on streaming media further includes the following steps.

A router receives, in real time, a streaming media data packet sent by each streaming media source end, copies the received streaming media data packet, delivers the copied streaming media data packet to routers that are deployed in advance in other server clusters than a server cluster in which the router is located, and forwards the copied streaming media data packet to multiple servers in the server cluster in which the router is located; and when the router receives streaming media data packets sent by other routers, the router copies the received streaming media data packets, and forwards the copied streaming media data packets to the multiple servers in the server cluster in which the router is located.

Herein, a streaming media source end may send a streaming media data packet of the streaming media source end to a preset router, and the router that receives the streaming media data packet copies and forwards the streaming media data packet.

In this embodiment, the step in which the server acquires, in real time, the streaming media data packet sent by each streaming media source end includes: receiving, by the server, the streaming media data packet forwarded by the router.

In this embodiment, multiple servers in multiple server clusters support processing of a streaming media data packet and processing of a streaming media search request, so that massive streaming media search requests can be processed simultaneously in real time. In addition, a router in each server cluster sends the streaming media data packet to routers in other server clusters than a server cluster in which the router is located, and the router then forwards the streaming media data packet to multiple servers in a same server cluster, which can reduce data transmission between the server clusters, thereby reducing occupation of a network bandwidth between the server clusters.

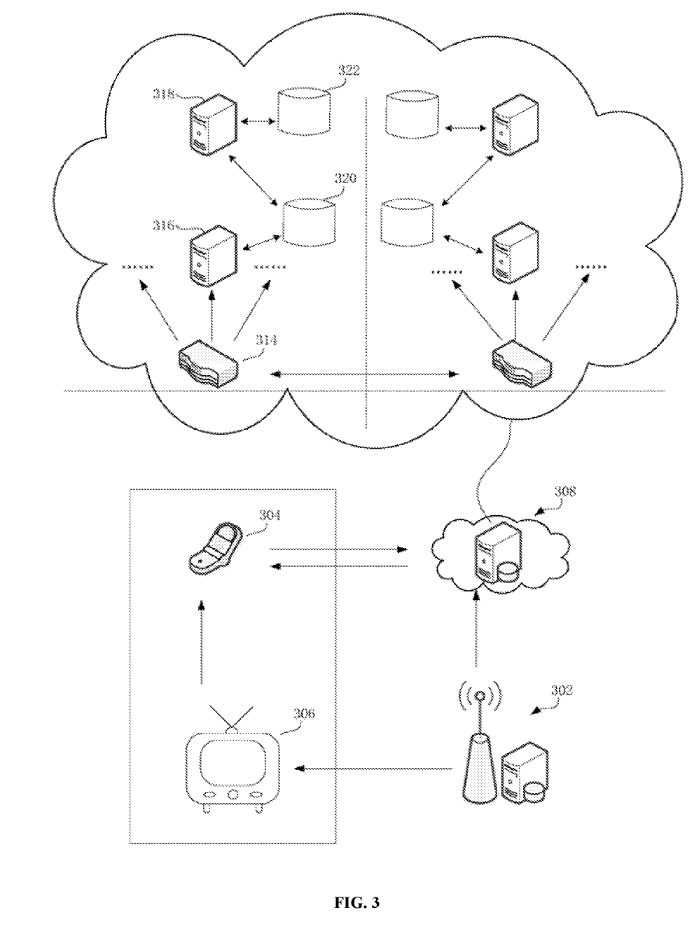

FIG. 3 is a schematic architectural diagram of a simulation application scenario of a client-server real-time interaction method based on streaming media in some embodiments. In FIG. 3, a terminal 304 is a mobile phone, and a multimedia playback device 306 is a television. However, in an actual application scenario, the terminal 304 may be a tablet computer, a notebook computer, a personal computer, a vehicle-mounted electronic device, a palm computer, or any other device capable of acquiring sounds, images, and/or videos; and the multimedia playback device 306 may be a radio, a mobile phone, or any other device that can receive a multimedia signal and play multimedia content. There may be multiple streaming media source ends 302, multiple terminals 304, and multiple multimedia playback devices 306.

As shown in FIG. 3, in some embodiments, a streaming media source end 302 transmits a multimedia signal to a multimedia playback device 306 in an environment in which a terminal 304 is located, and the terminal 304 can record sounds, images, and/or videos played by the multimedia playback device 306. Therefore, it can be considered that the terminal 304 and the multimedia playback device 306 are located in the same environment. At the same time, the streaming media source end 302 sends, to a server 308, a streaming media data packet corresponding to the multimedia signal, where the multimedia signal and the corresponding streaming media data packet are sent simultaneously, and it is possible that sending of the multimedia signal or of the corresponding streaming media data packet is delayed.

On the one hand, the server 308 acquires, in real time, a streaming media data packet sent by each streaming media source end, extracts streaming media features and a playback timestamp in the streaming media data packet of each streaming media source end, and stores, in a sequential order of corresponding playback timestamps, the extracted streaming media features in a streaming media feature sequence corresponding to a source end identifier of the streaming media source end to which the streaming media features belong.

On the other hand, the multimedia playback device 306 plays corresponding multimedia content in real time according to a multimedia signal received from the streaming media source end 302. When receiving a recording command triggered by a user, the terminal 304 may turn on an audio and video recorder (or a multimedia recorder), such as a microphone or a camera, record, by using the audio and video recorder which is turned on, sounds, images, and/or videos currently occurring in an environment in which the terminal is located, to obtain multimedia data, and generate a streaming media data packet according to the recorded multimedia data. The terminal 304 further generates a streaming media search request according to the streaming media data packet, and sends the generated streaming media search request to the server 308. The server 308 receives the streaming media search request sent by the terminal 304, identifies to-be-matched streaming media features according to the streaming media search request, searches a streaming media feature sequence of each streaming media source end 302 for a feature segment that matches the to-be-matched streaming media features, acquires a playback timestamp of the matching feature segment and a source end identifier of the streaming media source end to which the streaming media feature sequence belongs, searches for the preconfigured interaction response information that corresponds to the acquired source end identifier and the playback timestamp, and returns the corresponding interaction response information to the terminal 304.

As shown in FIG. 3, functions of the server 308 may be implemented by routers 314, feature generating servers 316, and real-time identification servers 318 that are deployed in multiple server clusters. Two server clusters are shown in FIG. 3, namely, server cluster A and server cluster B, but in an actual application scenario, the router 314, the feature generating server 316, and the real-time identification server 318 may be deployed in one or two or more server clusters. In each server cluster, at least one router 314, one or more feature generating servers 316, and one or more real-time identification servers 318 may be deployed.

A router 314 receives, in real time, a streaming media data packet sent by each streaming media source end, copies the received streaming media data packet, delivers the copied streaming media data packet to other routers 314 that are deployed in advance in other server clusters than a server cluster in which the router 314 is located, and forwards the copied streaming media data packet to multiple feature generating servers 316 in the server cluster in which the router 314 is located; and when the router 314 receives a streaming media data packet sent by other routers 314, the router 314 copies the received streaming media data packet, and forwards the copied streaming media data packet to the multiple feature generating servers 316 in the server cluster in which the router 314 is located.

The feature generating server 316 receives the streaming media data packet forwarded by the router 314, extracts streaming media features and a playback timestamp in the streaming media data packet of each streaming media source end, stores, in a sequential order of corresponding playback timestamps, the extracted streaming media features in a streaming media feature sequence corresponding to a source end identifier of the streaming media source end to which the streaming media features belong, and stores the streaming media feature sequence in a feature library 320.

The real-time identification server 318 receives the streaming media search request sent by the terminal 304, identifies to-be-matched streaming media features according to the streaming media search request, searches a streaming media feature sequence of each streaming media source end 302 in the feature library 320 for a feature segment that matches the to-be-matched streaming media features, acquires a playback timestamp of the matching feature segment and a source end identifier of the streaming media source end to which the streaming media feature sequence belongs, searches an interactive information library 322 for the acquired source end identifier and preconfigured interaction response information that corresponds to the playback timestamp, and returns the corresponding interaction response information to the terminal 304.

In some embodiments, the corresponding interaction response information includes additional information relevant to the streaming media search request sent by the terminal 304. As noted above in connection with FIG. 2B, the streaming media feature sequence 210 includes multiple media feature data tuples, each media feature data tuple further including a set of streaming media features, a corresponding playback timestamp, a time duration, and an interaction response identifier. Using the interaction response identifier, the real-time identification server 318 searches the interactive information library 322 for the preconfigured interaction response information that corresponds to the playback timestamp. Such preconfigured interaction response information may be related to a survey of viewers/audience that have been watching/listening to the streaming media played by the multimedia playback device 306. As shown in FIG. 2C, the interaction response information 220 may include one or more search keywords 228 associated with a particular streaming media segment. For example, assuming that the streaming media segment is part of a documentary film about Yellowstone National Park, the search keywords may include Yellowstone, weather, and lodging, etc. In response to the search request, the real-time identification server 318 may use the search keywords in the streaming media feature sequence to generate a new search request and submit the new search request to the search engine 324 and obtain a plurality of search results from the search engine 324 so that the search results can be returned to the terminal 304 along with the preconfigured interaction response information. In other words, the search results are usually more dynamic than the preconfigured interaction response information, which has been predefined by the server. Finally, different real-time identification servers 318 at different server clusters can receive and process different streaming media search requests.

In some embodiments, functions of the feature generating server 316 and functions of the real-time identification server 318 may be combined to be implemented on one server, and on a same server, the functions of the streaming media feature generating server 316 and the functions of the real-time identification server 318 may be separately implemented by two threads or two processes.

As shown in FIG. 4, in some embodiments, a real-time interaction system based on streaming media includes a terminal 402 and a real-time identification server 404.

The terminal 402 is configured to record a streaming media data packet in real time, generate a streaming media search request according to the recorded streaming media data packet, and send the generated streaming media search request to the real-time identification server 404.

The recording of a streaming media data packet in real time may include recording sounds, images, and/or videos in real time from a surrounding environment, to obtain a streaming media data packet. When a multimedia playback device in an environment in which the terminal 402 is located plays multimedia content, sounds, images, and/or videos must occur in the environment in which the terminal 402 is located. In some embodiments, when the terminal 402 receives a recording command triggered by a user, the terminal may start real-time recording of a streaming media data packet of the multimedia content. After recording for a preset duration, the terminal ends the real-time recording of the streaming media data packet. The terminal 402 may turn on an audio and video recorder (or a multimedia recorder), such as a microphone or a camera, record, by using the audio and video recorder which is turned on, sounds, images, and/or videos currently occurring in an environment in which the terminal is located, to obtain multimedia data, and generate a streaming media data packet according to recorded multimedia data.

Further, in some embodiments, the terminal 402 may encapsulate the streaming media data packet in the streaming media search request. In another embodiment, the terminal 402 may extract streaming media features of the streaming media data packet, and encapsulate the extracted streaming media features in the streaming media search request. The encapsulating the streaming media features of the streaming media data packet in the streaming media search request may reduce the amount of data included in the streaming media search request, and save a network bandwidth that is occupied during transmission of the streaming media search request.

The real-time identification server 404 is configured to acquire to-be-matched streaming media features according to the streaming media search request. The real-time identification server 404 includes one or more processors and memory for storing computer-executable instructions to be executed by the processors to perform the method of processing real-time streaming media as described in the present application. In some embodiments, the computer-executable instructions are stored in a non-transitory computer readable medium.

In some embodiments, the streaming media search request includes a streaming media data packet, and the real-time identification server 404 may extract the streaming media data packet included in the streaming media search request, and further extract streaming media features of the streaming media data packet. In another embodiment, the streaming media search request includes the streaming media features, and the real-time identification server 404 may directly extract the streaming media features from the streaming media search request.

Multimedia content indicated by the streaming media data packet may include audios, images, videos, or the like, and the streaming media features acquired by the real-time identification server 404 vary as the multimedia content that is indicated by the streaming media data packet varies. Correspondingly, the acquired streaming media features may include audio features, image features, video features (audio features and image features), or the like.

In some embodiments, the audio features may be an audio fingerprint. An audio fingerprint of an audio data packet may uniquely identify melody features of an audio indicated by the audio data packet. In some embodiments, the real-time identification server 404 may extract an audio fingerprint according to an MFCC algorithm, where MFCC is an abbreviation of Mel Frequency Cepstrum Coefficient. In some embodiments, the real-time identification server 404 may extract image features according to a Fourier transform method, a windowed Fourier transform method, a wavelet transform method, a least square method, an edge direction histogram method, or a texture feature extraction method based on Tamura texture features.

The real-time identification server 404 is further configured to search a streaming media feature sequence of each streaming media source end for a feature segment that matches the to-be-matched streaming media features, and acquires a playback timestamp of the matching feature segment and a source end identifier of the streaming media source end to which the streaming media feature sequence belongs, and the streaming media feature sequence performs real-time updating according to a plurality of streaming media data packets sent in real time by the streaming media source end to which the streaming media feature sequence belongs.

The streaming media feature sequence of the streaming media source end is a streaming media feature sequence that is extracted according to a streaming media data packet sequence of the streaming media source end, one or more streaming media data packets correspond to one streaming media feature, multiple streaming media features combine to form a streaming media feature sequence, a feature segment is a segment of streaming media features, and the feature segment includes one or more streaming media features. Therefore, the matching feature segment corresponds to a column of streaming media data packets, and the playback timestamp of the matching feature segment corresponds to a playback timestamp of multimedia content corresponding to the column of streaming media data packets. Each playback timestamp corresponds to specific multimedia playback content, and therefore, each playback timestamp of each streaming media source end may represent specific interactive information content, so that specific interaction response information can be preset for each playback timestamp of each streaming media source end.

The real-time identification server 404 is further configured to search for the preconfigured interaction response information that corresponds to the acquired source end identifier and the playback timestamp.

In some embodiments, the real-time identification server 404 is further configured to specify a source end identifier and interaction response information that corresponds to the playback timestamp. The interaction response information may be set according to the source end identifier and specific multimedia playback content that corresponds to the playback timestamp.

For example, if multimedia playback content corresponding to a playback timestamp of a streaming media source end is to vote for a contestant xx, the terminal 402 records the multimedia playback content in an environment in which the terminal is located to obtain a streaming media data packet, further generates a streaming media search request, and sends the streaming media search request to the real-time identification server 404, which may be equivalent to that the terminal 402 sends, to the real-time identification server 404, interactive information content that indicates “vote for the contestant”, so that the real-time identification server 404 can preset a source end identifier of the streaming media source end and preset interaction response information that corresponds to the playback timestamp as “succeed in voting for the contestant xx”.

For another example, if multimedia playback content corresponding to a playback timestamp of a streaming media source end is a link, in an award-winning question and answer activity, of acquiring question content, the terminal 402 records the multimedia playback content in an environment in which the terminal is located to obtain a streaming media data packet, further generates a streaming media search request, and sends the streaming media search request to the real-time identification server 404, which may be equivalent to that the terminal 402 sends, to the real-time identification server 404, interactive information content that indicates “acquire the question content”; in this way, the real-time identification server 404 can preset a source end identifier of the streaming media source end and preset interaction response information that corresponds to the playback timestamp to include the question content.

For another example, if multimedia playback content corresponding to a playback timestamp of a streaming media source end is a link of announcing a communication account, the terminal 402 records the multimedia playback content in an environment in which the terminal is located to obtain a streaming media data packet, further generates a streaming media search request, and sends the streaming media search request to the real-time identification server 404, which may be equivalent to that the terminal 402 sends, to the real-time identification server 404, interactive information content that indicates “request following the communication account” or “request adding the communication account to a friend list”; in this way, the real-time identification server 404 can preset a source end identifier of the streaming media source end and preset interaction response information that corresponds to the playback timestamp to include an interactive interface, where the interactive interface is used to determine whether a user confirms to “follow the communication account” or “add the communication account to a friend list”. The terminal 402 may further receive a user command through the interactive interface, and follow the communication account or add the communication account to a friend list according to the user command.

For another example, if multimedia playback content corresponding to a playback timestamp of a streaming media source end is a news and variety show, such as a teleplay, the terminal 402 records the multimedia playback content in an environment in which the terminal is located to obtain a streaming media data packet, further generates a streaming media search request, and sends the streaming media search request to the real-time identification server 404, which may be equivalent to that the terminal 402 sends, to the real-time identification server 404, interactive information content that indicates “comment on current program content”; in this way, the real-time identification server 404 can preset a source end identifier of the streaming media source end and preset interaction response information that corresponds to the playback timestamp to include an interactive interface, where the interactive interface is used to receive and submit a comment of a user on the current program content.

For another example, if multimedia playback content corresponding to a playback timestamp of a streaming media source end is a link of collecting feelings about watching/listening to a news and variety show, such as a teleplay, the terminal 402 records the multimedia playback content in an environment in which the terminal is located to obtain a streaming media data packet, further generates a streaming media search request, and sends the streaming media search request to the real-time identification server 404, which may be equivalent to that the terminal 402 sends, to the real-time identification server 404, interactive information content that indicates “request expressing feelings about watching/listening to a program”; in this way, the real-time identification server 404 can preset a source end identifier of the streaming media source end and preset interaction response information that corresponds to the playback timestamp to include an interactive interface, where the interactive interface is used to receive and submit feelings of a user on a teleplay.

For another example, if multimedia playback content corresponding to a playback timestamp of a streaming media source end is a link of introducing product information related to a product, the terminal 402 records the multimedia playback content in an environment in which the terminal is located to obtain a streaming media data packet, further generates a streaming media search request, and sends the streaming media search request to the real-time identification server 404, which may be equivalent to that the terminal 402 sends, to the real-time identification server 404, interactive information content that indicates “require buying the product” or “hope to know more details about the product”; in this way, the real-time identification server 404 can preset a source end identifier of the streaming media source end and preset interaction response information that corresponds to the playback timestamp to include an interactive interface, where the interactive interface is used to display the details about the product or/and receive and submit a product buying command of a user.

The real-time identification server 404 may further be configured to divide the playback timestamp into time segments as required, for example, the length of each time segment is 5 minutes. The real-time identification server 404 may further be configured to set that playback timestamps, which belong to a same time segment, of a streaming media source end correspond to same interaction response information, and the length of the time segment determines time granularity of the interaction response information.

The real-time identification server 404 is further configured to return the corresponding interaction response information to the terminal 402.

In some embodiments, the terminal 402 is further configured to play the interaction response information. The terminal 402 may parse the interaction response information, and play the interaction response information by selecting corresponding software according to audios, images and/or videos included in the interaction response information.

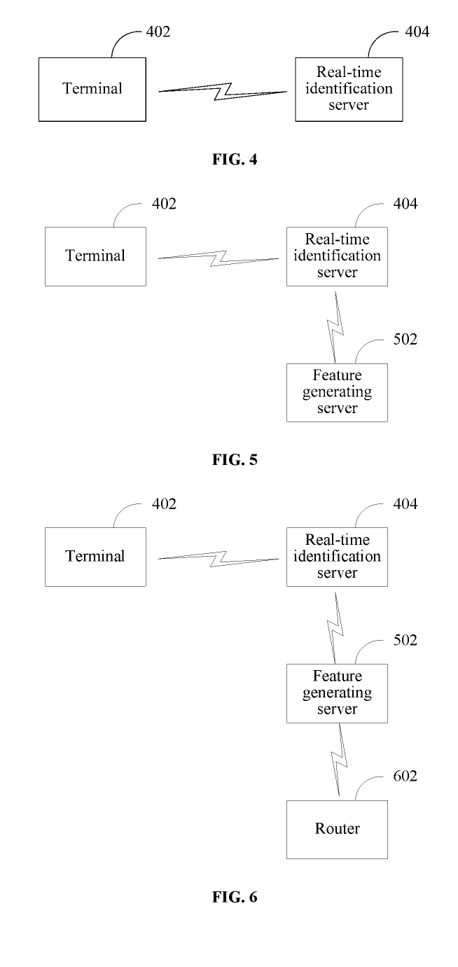

As shown in FIG. 5, in some embodiments, the foregoing real-time interaction system based on streaming media further includes a feature generating server 502, configured to acquire, in real time, a streaming media data packet sent by each streaming media source end.

The feature generating server 502 and the streaming media source end may agree on a network transmission protocol in any form, such as a TCP protocol or a UDP protocol. In some embodiments, the feature generating server 502 may receive, in push mode, the streaming media data packet sent by each streaming media source end. In push mode, the feature generating server 502 may listen on a locally preset port, and wait for the streaming media source end to send the streaming media data packet to the port. In another embodiment, the feature generating server 502 may receive, in pull mode, the streaming media data packet sent by each streaming media source end. In pull mode, the streaming media source end provides a streaming media data packet on a preset port of the server in a network environment in which the streaming media source end is located, and the feature generating server 502 can proactively pull the streaming media data packet from the preset port.

The feature generating server 502 is further configured to extract streaming media features and a playback timestamp in the streaming media data packet of each streaming media source end.

In some embodiments, the feature generating server 502 may parse the streaming media data packet, to obtain a multimedia type (such as audio, image, or video) encapsulated in the streaming media data packet and a multimedia encapsulation format (for example, a TS format is used for encapsulation, and a MP3 format with a sampling rate of 48 k is used for coding), further decode multimedia data in the streaming media data packet according to the encapsulated multimedia type and the multimedia encapsulation format, and further extract streaming media features and a playback timestamp of the multimedia data.

In some embodiments, the feature generating server 502 may extract a streaming media feature and a playback timestamp from one streaming media data packet, or may extract a streaming media feature and a playback timestamp from multiple streaming media data packets. A playback timestamp of one streaming media data packet may be a playback start time point of multimedia playback content corresponding to the streaming media data packet, and playback timestamps of multiple streaming media data packets may be earliest playback start time points of multiple corresponding pieces of multimedia playback content.

The feature generating server 502 is further configured to store, in a sequential order of corresponding playback timestamps, the extracted streaming media features in a streaming media feature sequence corresponding to a source end identifier of the streaming media source end to which the streaming media features belong.

The streaming media source end to which the streaming media features belong is a streaming media source end to which the streaming media data packet corresponding to the streaming media features belongs. The feature generating server 502 may form the streaming media features and the playback timestamp of each streaming media data packet into a feature data pair, form multiple feature data pairs of a same streaming media source end into a feature data pair sequence of the streaming media source end, further sort feature data pair sequences of streaming media source ends according to playback timestamps, and correspondingly store the sorted feature data pairs and corresponding source end identifiers.

In some embodiments, a time interval between the earliest playback timestamp and the latest playback timestamp that correspond to the streaming media features in the streaming media feature sequence is maintained within a threshold.

In some embodiments, the feature generating server 502 maintains the streaming media feature sequence in a first-in-first-out manner. To do so, the feature generating server 502 periodically checks whether a time interval between the earliest playback timestamp and the latest playback timestamp that correspond to the streaming media feature sequence reaches the threshold; if not, append the extracted streaming media features and the corresponding playback timestamps to the end of the streaming media feature sequence; and if yes, determine a number of the extracted streaming media features to be added to the streaming media feature sequence, remove the same number of streaming media features that have the earliest playback timestamps from the streaming media feature sequence, and append the extracted streaming media features and the corresponding playback timestamps to the end of the streaming media feature sequence.

In some embodiments, the feature generating server 502 may preset a threshold for a time interval between the earliest playback timestamp and the latest playback timestamp that correspond to already stored streaming media features, such as 1 hour, 30 minutes, or 5 minutes. In some embodiments, the feature generating server 502 may acquire a data amount of the streaming media feature sequence at a time when a time interval between the earliest playback timestamp and the latest playback timestamp that correspond to the streaming media feature sequence reaches the threshold, where the streaming media features in the streaming media feature sequence are sorted according to playback timestamps. Further, a capacity of a circular buffer may be set as the data amount of the streaming media feature sequence at a time when the time interval between the earliest playback timestamp and the latest playback timestamp reaches the threshold. Further, the extracted streaming media features are stored, in a manner of the circular buffer and in the sequential order of the corresponding playback timestamps, in the streaming media feature sequence corresponding to the source end identifier of the streaming media source end to which the streaming media features belong, and the time interval between the earliest playback timestamp and the latest playback timestamp that correspond to the streaming media features in the streaming media feature sequence are made to maintain within the threshold.

In some embodiments, the feature generating server 502 is further configured to generate an index for a stored streaming media feature sequence of each streaming media source end. In this embodiment, the real-time identification server 404 may search the index of the streaming media feature sequence of each streaming media source end for an index segment that matches to-be-matched streaming media features, and obtain, according to the matching index segment, a feature segment that matches the to-be-matched streaming media features.

As shown in FIG. 6, in some embodiments, the foregoing real-time interaction system based on streaming media further includes a router 602, configured to receive, in real time, a streaming media data packet sent by each streaming media source end, copy the received streaming media data packet, deliver the copied streaming media data packet to other routers 602 that are deployed in advance in other server clusters than a server cluster in which the router 602 is located, and forward the copied streaming media data packet to multiple feature generating servers 502 in the server cluster in which the router 602 is located; and the router 602 is further configured to: when receiving a streaming media data packet sent by the other routers 602, copy the received streaming media data packet, and forward the copied streaming media data packet to the multiple feature generating servers 502 in the server cluster in which the router 602 is located.

Herein, a streaming media source end may send a streaming media data packet of the streaming media source end to a preset router 602, and the router 602 that receives the streaming media data packet copies and forwards the streaming media data packet.

In this embodiment, the router 602 may receive, in push mode or in pull mode, the streaming media data packet sent by each streaming media source end. The feature generating server 502 may receive the streaming media data packet forwarded by the router 602.

In this embodiment, multiple feature generating servers 502 in multiple server clusters support processing of a streaming media data packet, and multiple real-time identification servers 404 support processing of a streaming media search request, so that massive streaming media search requests can be processed simultaneously in real time. In addition, a router 602 in each server cluster sends the streaming media data packet to routers 602 in other server clusters than a server cluster in which the router 602 is located, and the router 602 then forwards the streaming media data packet to multiple feature generating servers 502 in a same server cluster, which can reduce data transmission between the server clusters, thereby reducing occupation of a network bandwidth between the server clusters.

In some embodiments, functions of the feature generating server 502 and functions of the real-time identification server 404 may be combined to be implemented on one server, and on a same server, the functions of the feature generating server 502 and the functions of the real-time identification server 404 may be separately implemented by two threads or two processes.

It should be noted that the foregoing real-time interaction system based on streaming media may include multiple terminals 402, multiple real-time identification servers 404, multiple feature generating servers 502, and multiple routers 602, where the multiple real-time identification servers 404, the multiple feature generating servers 502, and the multiple routers 602 may be deployed in multiple server clusters, and in each server cluster, at least one router 602, one or more feature generating servers 502, and one or more real-time identification servers 404 may be deployed.

In the foregoing client-server real-time interaction method and system based on streaming media, a terminal does not need to obtain, from input of a user, a communication number and interactive information content of a target streaming media source end with which the user interacts, and the terminal can record, in real time, sounds, images, and/or videos currently occurring in an environment in which the terminal is located to obtain a streaming media data packet, and send, to a server, a streaming media search request that is generated according to the recorded streaming media data packet. On the one hand, the server can receive the streaming media data packet from each streaming media source end in real time, and update, in real time, a corresponding streaming media feature sequence according to the streaming media data packet that is received in real time, thereby ensuring timeliness of the streaming media feature sequence of each streaming media source end maintained by the server. On the other hand, when receiving the streaming media search request sent by the terminal, the server can acquire to-be-matched streaming media features according to the streaming media search request, search the streaming media feature sequence of each streaming media source end for a feature segment that matches the streaming media features, and acquire a playback timestamp of the matching feature segment and a source end identifier of the streaming media source end to which the streaming media feature sequence belongs; and further search for the preconfigured interaction response information that corresponds to the acquired source end identifier and the playback timestamp, and return the interaction response information to the terminal, thereby achieving real-time interaction between the terminal and the server for the target streaming media source end.

In the whole interaction process, one the one hand, the server can automatically identify the target streaming media source end with which the user interacts and the corresponding playback timestamp when the user participates in the interaction, and the playback timestamp corresponds to corresponding playback content, thereby representing corresponding interactive information content; in this way, the terminal does not need to acquire, from input of the user, the target streaming media source end in the interaction and the interactive information content, thereby saving input time. On the other hand, the server updates, according to the streaming media data packet that is received in real time, the corresponding streaming media feature sequence in real time, thereby ensuring timeliness of the streaming media feature sequence of each streaming media source end maintained by the server. Therefore, in a case in which the following two processes synchronizes, that is, the streaming media source end sends the streaming media data packet to the server in real time, and the terminal plays, in real time in an environment in which the terminal is located, multimedia content corresponding to the streaming media data packet of the streaming media source end, the real-time interaction between the terminal and the server for the target streaming media source end can be achieved rapidly and correctly.

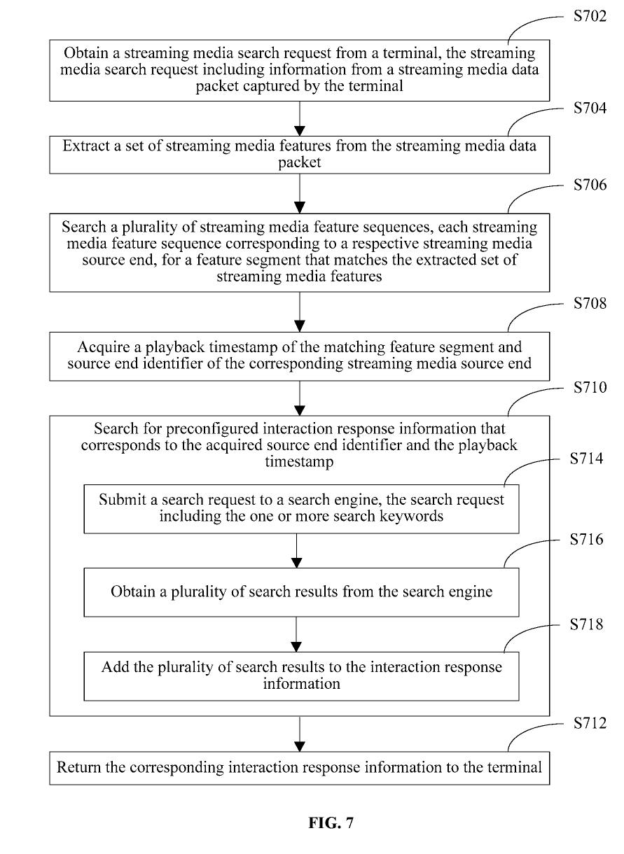

FIG. 7 is a schematic flowchart of a computer server processing a client-server real-time interaction method based on streaming media in some embodiments. The computer server (e.g., the real-time identification server 404) obtains (S702) a streaming media based search request from a terminal (e.g., a mobile phone). The streaming media based search request includes information from a streaming media data packet captured by the terminal. In some embodiments, the streaming media based search request includes the streaming media data packet itself. Next, the computer server extracts (S704) a set of streaming media features from the streaming media data packet and searches (S706) a plurality of streaming media feature sequences, each streaming media feature sequence corresponding to a respective streaming media source end, for a feature segment that matches the extracted set of streaming media features. As noted above, the computer server has access to one or more feature libraries, each feature library includes one or more streaming media feature sequences extracted from the streaming media packets submitted by different streaming source ends. After identifying a streaming media feature segment (e.g., a set of streaming media features from a particular source end), the computer server acquires (S708) a playback timestamp of the matching feature segment and a source end identifier of the corresponding streaming media source end. As noted above, such information is stored in the data structure depicted in FIG. 2B. Next, the computer server searches (S710) for preconfigured interaction response information that corresponds to the acquired source end identifier and the playback timestamp and returns (S712) the corresponding interaction response information to the terminal. As noted above in connection with FIG. 2C, the corresponding interaction response information may include more than the preconfigured interaction response information that corresponds to the acquired source end identifier and the playback timestamp. For example, the computer server may identify one or more search keywords associated with the matching streaming media feature segment and then generate a search request using the search keywords. The computer server then submits (S714) the search request to the search engine and obtains (S716) a plurality of search results from the search engine. The search results are then added (S718) to the corresponding interaction response information so that the viewer at the terminal can receive additional dynamically-generated information related to the streaming media packet captured by the terminal.

While particular embodiments are described above, it will be understood it is not intended to limit the invention to these particular embodiments. On the contrary, the present application includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the present application herein is for the purpose of describing particular embodiments only and is not intended to be limiting of the invention. As used in the description of the present application and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present application and its practical applications, to thereby enable others skilled in the art to best utilize the present application and various embodiments with various modifications as are suited to the particular use contemplated.

What is claimed is:

1. A method of processing real-time streaming media, the method comprising:
at a computer system having one or more processors and memory for storing computer-executable instructions to be executed by the processors:
obtaining a streaming media based search request from a terminal, the streaming media based search request including information from a streaming media data packet captured by the terminal;
extracting a set of streaming media features from the streaming media data packet;
searching a plurality of streaming media feature sequences, each streaming media feature sequence corresponding to a respective streaming media source end, for a feature segment that matches the extracted set of streaming media features;
acquiring a playback timestamp of the matching feature segment and a source end identifier of the corresponding streaming media source end;
searching for preconfigured interaction response information that corresponds to the acquired source end identifier and the playback timestamp; and
returning the corresponding interaction response information to the terminal.

2. The method of claim 1, wherein a streaming media feature sequence is generated by:
acquiring, in real time, a plurality of streaming media data packets sent by a corresponding streaming media source end;
extracting streaming media features and corresponding playback timestamps from the streaming media data packets of the streaming media source end; and
storing, in a sequential order of the playback timestamps, the extracted streaming media features and their corresponding playback timestamps in the streaming media feature sequence.

3. The method of claim 2, wherein a time interval between an earliest playback timestamp and a latest playback timestamp that correspond to the streaming media feature sequence is maintained within a predefined threshold.

4. The method of claim 3, wherein storing, in a sequential order of the playback timestamps, the extracted streaming media features and their corresponding playback timestamps in the streaming media feature sequence further includes:
periodically checking whether the time interval reaches the predefined threshold;
when the time interval does not reach the predefined threshold, appending the extracted streaming media features and the corresponding playback timestamps to the end of the streaming media feature sequence; and
when the time interval reaches the predefined threshold:
determining a number of the extracted streaming media features to be added to the streaming media feature sequence;
removing the same number of streaming media features that have the earliest playback timestamps from the streaming media feature sequence in a first-in-first-out manner; and
appending the extracted streaming media features and the corresponding playback timestamps to the end of the streaming media feature sequence.

5. The method of claim 2, wherein the streaming media feature sequence includes a plurality of media feature data tuples, each media feature data tuple further including a set of streaming media features, a corresponding playback timestamp, a time duration, and an interaction response identifier.

6. The method of claim 5, wherein the interaction response identifier identifies interaction response information associated with the media feature data tuple, the interaction response information further including preconfigured interaction response information, real-time interaction statistics information, and one or more search keywords.

7. The method of claim 6, wherein searching for preconfigured interaction response information that corresponds to the acquired source end identifier and the playback timestamp further includes:
submitting a search request to a search engine, the search request including the one or more search keywords;
obtaining a plurality of search results from the search engine; and
adding the plurality of search results to the interaction response information so that the plurality of search results are returned to the terminal along with the preconfigured interaction response information.

8. A computer system comprising:
one or more processors; and
memory with computer-executable instructions stored thereon that, when executed by the one or more computer processors, cause the one or more computer processors to perform operations comprising;
obtaining a streaming media based search request from a terminal, the streaming media based search request including information from a streaming media data packet captured by the terminal;
extracting a set of streaming media features from the streaming media data packet;
searching a plurality of streaming media feature sequences, each streaming media feature sequence corresponding to a respective streaming media source end, for a feature segment that matches the extracted set of streaming media features;
acquiring a playback timestamp of the matching feature segment and a source end identifier of the corresponding streaming media source end;
searching for preconfigured interaction response information that corresponds to the acquired source end identifier and the playback timestamp; and
returning the corresponding interaction response information to the terminal;

9. The computer system of claim 8, wherein a streaming media feature sequence is generated by performing the following instructions:
acquiring, in real time, a plurality of streaming media data packets sent by a corresponding streaming media source end;
extracting streaming media features and corresponding playback timestamps from the streaming media data packets of the streaming media source end; and
storing, in a sequential order of the playback timestamps, the extracted streaming media features and their corresponding playback timestamps in the streaming media feature sequence.

10. The computer system of claim 9, wherein a time interval between an earliest playback timestamp and a latest playback timestamp that correspond to the streaming media feature sequence is maintained within a predefined threshold.

11. The computer system of claim 10, wherein the instruction for storing, in a sequential order of the playback timestamps, the extracted streaming media features and their corresponding playback timestamps in the streaming media feature sequence further includes instructions for:
periodically checking whether the time interval reaches the predefined threshold;
when the time interval does not reach the predefined threshold, appending the extracted streaming media features and the corresponding playback timestamps to the end of the streaming media feature sequence; and
when the time interval reaches the predefined threshold:
determining a number of the extracted streaming media features to be added to the streaming media feature sequence;
removing the same number of streaming media features that have the earliest playback timestamps from the streaming media feature sequence in a first-in-first-out manner; and
appending the extracted streaming media features and the corresponding playback timestamps to the end of the streaming media feature sequence.

12. The computer system of claim 9, wherein the streaming media feature sequence includes a plurality of media feature data tuples, each media feature data tuple further including a set of streaming media features, a corresponding playback timestamp, a time duration, and an interaction response identifier; wherein the interaction response identifier identifies interaction response information associated with the media feature data tuple, the interaction response information further including preconfigured interaction response information, real-time interaction statistics information, and one or more search keywords.

13. The computer system of claim 12, wherein the instruction for searching for preconfigured interaction response information that corresponds to the acquired source end identifier and the playback timestamp further includes instructions for:
submitting a search request to a search engine, the search request including the one or more search keywords;
obtaining a plurality of search results from the search engine; and
adding the plurality of search results to the interaction response information so that the plurality of search results are returned to the terminal along with the preconfigured interaction response information.

14. A non-transitory computer readable medium storing computer-executable instructions, wherein the computer-executable instructions, when executed by a computer system having one or more processors, cause the computer system to perform the following operations:
obtaining a streaming media based search request from a terminal, the streaming media based search request including information from a streaming media data packet captured by the terminal;
extracting a set of streaming media features from the streaming media data packet;
searching a plurality of streaming media feature sequences, each streaming media feature sequence corresponding to a respective streaming media source end, for a feature segment that matches the extracted set of streaming media features;
acquiring a playback timestamp of the matching feature segment and a source end identifier of the corresponding streaming media source end;
searching for preconfigured interaction response information that corresponds to the acquired source end identifier and the playback timestamp; and
returning the corresponding interaction response information to the terminal;

15. The non-transitory computer readable medium 14, wherein a streaming media feature sequence is generated by performing the following instructions:
acquiring, in real time, a plurality of streaming media data packets sent by a corresponding streaming media source end;
extracting streaming media features and corresponding playback timestamps from the streaming media data packets of the streaming media source end; and
storing, in a sequential order of the playback timestamps, the extracted streaming media features and their corresponding playback timestamps in the streaming media feature sequence.

16. The non-transitory computer readable medium 15, wherein a time interval between an earliest playback timestamp and a latest playback timestamp that correspond to the streaming media feature sequence is maintained within a predefined threshold.

17. The non-transitory computer readable medium 16, wherein the instruction for storing, in a sequential order of the playback timestamps, the extracted streaming media features and their corresponding playback timestamps in the streaming media feature sequence further includes instructions for:
periodically checking whether the time interval reaches the predefined threshold;
when the time interval does not reach the predefined threshold, appending the extracted streaming media features and the corresponding playback timestamps to the end of the streaming media feature sequence; and
when the time interval reaches the predefined threshold:
determining a number of the extracted streaming media features to be added to the streaming media feature sequence;
removing the same number of streaming media features that have the earliest playback timestamps from the streaming media feature sequence in a first-in-first-out manner; and
appending the extracted streaming media features and the corresponding playback timestamps to the end of the streaming media feature sequence.

18. The non-transitory computer readable medium 15, wherein the streaming media feature sequence includes a plurality of media feature data tuples, each media feature data tuple further including a set of streaming media features, a corresponding playback timestamp, a time duration, and an interaction response identifier.

19. The non-transitory computer readable medium 18, wherein the interaction response identifier identifies interaction response information associated with the media feature data tuple, the interaction response information further including preconfigured interaction response information, real-time interaction statistics information, and one or more search keywords.

20. The non-transitory computer readable medium 19, wherein the instruction for searching for preconfigured interaction response information that corresponds to the acquired source end identifier and the playback timestamp further includes instructions for:
submitting a search request to a search engine, the search request including the one or more search keywords;
obtaining a plurality of search results from the search engine; and
adding the plurality of search results to the interaction response information so that the plurality of search results are returned to the terminal along with the preconfigured interaction response information.
